(19) United States
(12) Patent Application Publication
(10) Pub. No.: US 2023/0073340 A1
(43) Pub. Date: Mar. 9, 2023

(54) METHOD FOR CONSTRUCTING THREE-DIMENSIONAL HUMAN BODY MODEL, AND ELECTRONIC DEVICE

(71) Applicant: BEIJING DAJIA INTERNET INFORMATION TECHNOLOGY CO., LTD., Beijing (CN)

(72) Inventors: Yanpei CAO, Beijing (CN); Peiyao ZHAO, Beijing (CN)

(21) Appl. No.: 18/049,975

(22) Filed: Oct. 26, 2022

Related U.S. Application Data
(63) Continuation of application No. PCT/CN2020/139594, filed on Dec. 25, 2020.

(30) Foreign Application Priority Data
Jun. 19, 2020 (CN) 202010565641.7

(51) Int. Cl. G06T 17/20; G06T 7/73

(52) U.S. Cl. CPC G06T 17/20; G06T 7/75; G06T 2207/30196

(57) ABSTRACT

Provided is a method for constructing a three-dimensional human body model. The method includes: acquiring image feature information of a human body region by inputting a target image containing the human body region into a feature extraction network; acquiring a position of a first three-dimensional human body mesh vertex by inputting the image feature information into a fully-connected vertex reconstruction network; and constructing the three-dimensional human body model based on a target connection relationship between three-dimensional human body mesh vertices as well as the position of the first three-dimensional human body mesh vertex.

### CROSS REFERENCE TO RELATED APPLICATION

This disclosure is a continuation application of International Application No. PCT/CN2020/139594, filed on Dec. 25, 2020, which claims priority to Chinese Patent. Application No. 202010565641.7, filed on Jun. 19, 2020, the disclosures of which are herein incorporated by reference in their entireties.

### TECHNICAL FIELD

The present disclosure relates to the field of computer technologies, and in particular, relates to a method for constructing a three-dimensional human body model, and an electronic device.

### BACKGROUND

With the development of image processing technologies, an important application of machine vision algorithms is to reconstruct a three-dimensional human body model based on image data. After the three-dimensional human body model is reconstructed from an image, the acquired three-dimensional human body model can be applied to various fields such as film and television entertainment, medical health, and education.

### SUMMARY

According to some embodiments of the present disclosure, a method for constructing a three-dimensional human body model is provided. The method includes: acquiring image feature information of a human body region by inputting a target image containing the human body region into a feature extraction network in a three-dimensional reconstruction model; acquiring a position of a first three-dimensional human body mesh vertex corresponding to the human body region by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process; and constructing the three-dimensional human body model corresponding to the human body region based on a target connection relationship between three-dimensional human body mesh vertices and the position of the first three-dimensional human body mesh vertex.

According to some embodiments of the present disclosure, an electronic device is provided, including: one or more processors; and a memory configured to store one or more instructions executable by the one or more processors, wherein the one or more processors, when loading and executing the one or more instructions, are caused to perform: acquiring image feature information of a human body region by inputting a target image containing the human body region into a feature extraction network in a three-dimensional reconstruction model; acquiring a position of a first three-dimensional human body mesh vertex corresponding to the human body region by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process; and constructing the three-dimensional human body model corresponding to the human body region based on a target connection relationship between three-dimensional human body mesh vertices and the position of the first three-dimensional human body mesh vertex.

According to some embodiments of the present disclosure, a non-transitory computer-readable storage medium storing one or more instructions therein, wherein the one or more instructions, when loaded and executed by a processor of an electronic device, cause the electronic device to perform: acquiring image feature information of a human body region by inputting a target image containing the human body region into a feature extraction network in a three-dimensional reconstruction model; acquiring a position of a first three-dimensional human body mesh vertex corresponding to the human body region by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process; and constructing the three-dimensional human body model corresponding to the human body region based on a target connection relationship between three-dimensional human body mesh vertices and the position of the first three-dimensional human body mesh vertex.

### BRIEF DESCRIPTION OF THE DRAWINGS

FIG. 1 is a flowchart of a method for constructing a three-dimensional human body model according to some embodiments of the present disclosure;

FIG. 2 is a schematic diagram of an application scene according to some embodiments of the present disclosure;

FIG. 3 is a schematic structural diagram of a feature extraction network according to some embodiments of the present disclosure;

FIG. 4 is a schematic structural diagram of a fully-connected vertex reconstruction network according to some embodiments of the present disclosure;

FIG. 5 is a schematic structural diagram of nodes in a hidden layer in a fully-connected vertex reconstruction network according to some embodiments of the present disclosure;

FIG. 6 is a schematic partial structural diagram of a three-dimensional human body model according to some embodiments of the present disclosure;

FIG. 7 is a schematic diagram of a training process according to some embodiments of the present disclosure;

FIG. 8 is a block diagram of an apparatus for constructing a three-dimensional human body model according to some embodiments of the present disclosure;

FIG. 9 is a block diagram of another apparatus for constructing a three-dimensional human body model according to some embodiments of the present disclosure;

FIG. 10 is a block diagram of yet another apparatus for constructing a three-dimensional human body model according to some embodiments of the present disclosure; and

FIG. 11 is a block diagram of an electronic device according to some embodiments of the present disclosure.

### DETAILED DESCRIPTION

Some terms in the embodiments of the present disclosure are explained hereinafter to facilitate the understanding of those skilled in the art.

(1) The term “a plurality of” in the embodiments of the present disclosure refers to two or more than two, and other quantifiers are similar to it.

(2) The term “terminal device” in the embodiments of the present disclosure refers to a device that can be installed with various applications and display objects provided in the installed applications. The terminal device may be mobile or fixed and may be, such as a mobile phone, a tablet computer, various wearable devices, a vehicle-mounted device, a personal digital assistant (PDA), a point of sales (POS), and other terminal devices that can realize the above functions.

(3) The term “convolutional neural network” in the embodiments of the present disclosure refers to a class of feedforward neural networks that contain convolutional calculation and have deep structures, is one of the representative algorithms of deep learning, has a representation learning ability, and can perform shift-invariant classification on input information according to its hierarchical structure.

(4) The term “machine learning” in the embodiments of the present disclosure refers to a multi-field interdisciplinary subject which involves in probability theory, statistics, approximation theory, convex analysis, algorithm complexity theory and other disciplines, and specializes in the study of how computers simulate or realize human learning behaviors to acquire new knowledge or skills to reorganize existing knowledge structures to continuously improve their own performance.

With the development of image processing technologies, machine vision algorithm has been used to construct a three-dimensional human body model based on image data so as to reproduce a human body in an image. A large number of application scenes need to use human body data acquired based on the three-dimensional human body model. For example, in the field of film and television entertainment, the human body data acquired based on the three-dimensional human body model is used to drive three-dimensional animated characters to automatically generate animations. In another example, in the field of medical health, the human body data acquired based on the three-dimensional human body model is used to analyze the limb movement and muscle exertion behavior of a photographed human body. However, the conventional methods of constructing a three-dimensional human body mode usually require photo shooting at specific scenes. There are various issues for constructions of a three-dimensional human body mode using the conventional methods, such as, restricted conditions for photo shooting, complicated construction process, a large amount of computation, which can result in low efficiency on construction of a three-dimensional human body model.

The embodiments of the present disclosure are described in further detail below.

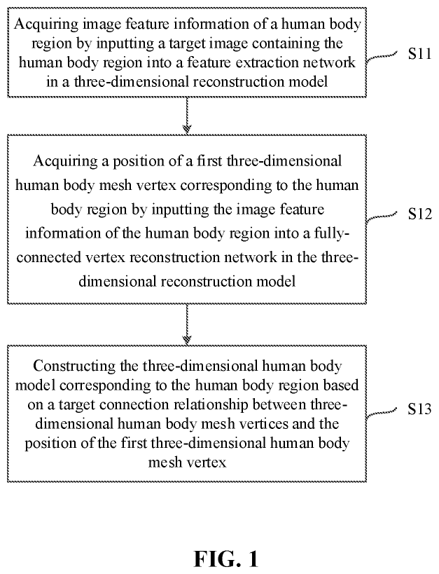

FIG. 1 is a flowchart of a method for constructing a three-dimensional human body model according to some embodiments of the present disclosure. As shown in FIG. 1, the method is executed by an electronic device and includes the following steps.

In S11, image feature information of a human body region is acquired by inputting a target image containing the human body region into a feature extraction network in a three-dimensional reconstruction model, wherein the target image is an image to be detected.

In S12, a position of a first three-dimensional human body mesh vertex corresponding to the human body region is acquired by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process.

In S13, the three-dimensional human body model corresponding to the human body region is constructed based on a target connection relationship between three-dimensional human body mesh vertices and the position of the first three-dimensional human body mesh vertex.

According to the method for constructing the three-dimensional human body model provided by the embodiments of the present disclosure, the image feature information of the human body region in the target image is determined by extracting features of the target image containing the human body region; the position of the first three-dimensional human body mesh vertex corresponding to the human body region in the target image is acquired by decoding the image feature information using the fully-connected vertex reconstruction network in the three-dimensional reconstruction model; and the three-dimensional human body model is constructed based on the target connection relationship between the three-dimensional human body mesh vertices and the position of the first three-dimensional human body mesh vertex.

The method for constructing the three-dimensional human body model according to the embodiments of the present disclosure can construct a three-dimensional human body model by using a target image taken by an image collection device rather than taking photos in required specific scene, and thus is less costly in the construction process. Further, according to the embodiments of the present disclosure, since a fully-connected vertex reconstruction network acquired by performing consistency constraint training on a graph convolutional neural network is used in the construction rather than directly use of a graph convolutional neural network, the calculation efficiency can be improved while the degree of accuracy of the position of the first three-dimensional human body mesh vertex is ensured through the specifically trained fully-connected vertex reconstruction network. In this way, the three-dimensional human body model can be constructed efficiently and accurately.

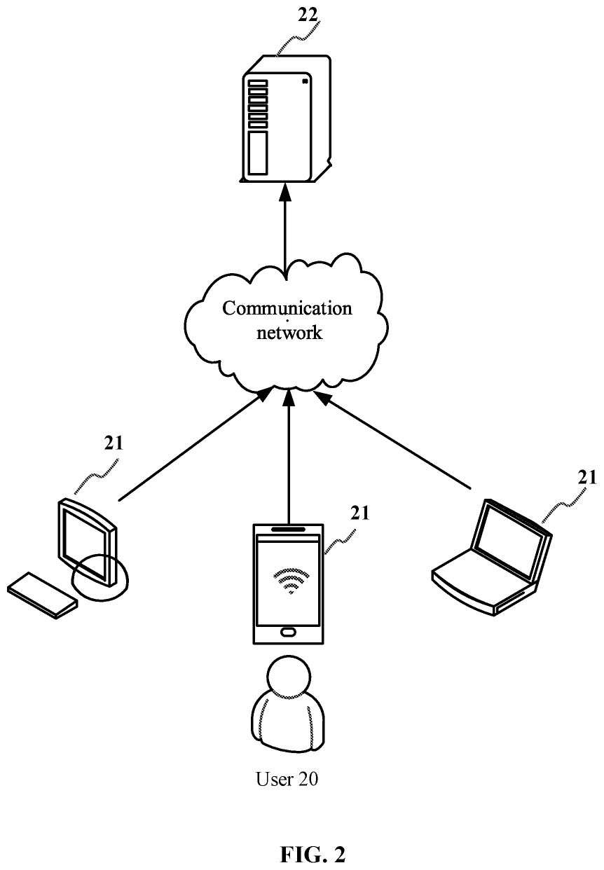

In some embodiments, in an application scene shown in FIG. 2, each of terminal devices 21 is equipped with an image collection device. In some embodiments, in the case that a user 20 collects a target image containing a human body region based on the image collection devices of the terminal devices 21, the image collection devices send the collected target image to a server 22. The server 22 inputs the target image into a feature extraction network in a three-dimensional reconstruction model, and the feature extraction network performs feature extraction on the target image to acquire image feature information of the human body region. The server 22 inputs the image feature information of the human body region into a fully-connected vertex reconstruction network in the three-dimensional reconstruction model to acquire the position of a first three-dimensional human body mesh vertex corresponding to the human body region, and constructs a three-dimensional human body model corresponding to the human body region based on a target connection relationship between three-dimensional human body mesh vertices and the position of the first three-dimensional human body mesh vertex. The server 22 sends the three-dimensional human body model corresponding to the human body region in the target image to the image collection devices in the terminal devices 21, and the image collection devices perform corresponding processing based on the acquired three-dimensional human body model. In one example of animation, the image collection devices acquire human body data based on the acquired three-dimensional human body model, such that three-dimensional animated characters are driven based on the human body data, and the animated characters are displayed to the user 20. That is, based on a target image collected by a collection device of a terminal, various images of the animated characters can be created based on the three-dimensional human body model constructed according to the embodiments of the present invention.

It should be noted that, in the above application scene, the target connection relationship refers to a preset connection relationship between the three-dimensional human body mesh vertices. In some embodiments, the target connection relationship has been stored in the server 22; or in the case that the image collection devices send the target image to the server 22, the target connection relationship is sent to the server 22 together. The above application scene is only exemplary, and does not constitute a limitation on the protection scope of the embodiments of the present disclosure.

According to the method for constructing the three-dimensional human body model provided by the embodiments of the present disclosure, the three-dimensional human body model is constructed through the three-dimensional reconstruction model. The three-dimensional reconstruction model includes the feature extraction network, the fully-connected vertex reconstruction network and the graph convolutional neural network in the training process. In this process, the consistency constraint training is performed on the fully-connected vertex reconstruction network and the graph convolutional neural network. After training, the graph convolutional neural network with relatively large computation capacity and storage capacity is deleted and the trained three-dimensional reconstruction model is acquired. The trained three-dimensional reconstruction model contains only the feature extraction network and the fully-connected vertex reconstruction network, which is more efficient in construction of three-dimensional human body model.

In the case that the three-dimensional human body model is constructed through the trained three-dimensional reconstruction model, after the target image containing the human body region is acquired, firstly, image feature information of the human body region in the target image is acquired by performing feature extraction on the target image.

In some embodiments, the image feature information of the human body region is acquired by inputting the target image into a feature extraction network in the three-dimensional reconstruction model.

In some embodiments, prior to calling the trained feature extraction network, the feature extraction network is trained by a large number of images containing the human body region, and a training sample during the training of the feature extraction network includes a sample image containing the human body region and the position of a labeled human body vertex of the sample image; and the position of the labeled human body vertex is pre-labeled and can be used as tag information to participate in the training process of the feature extraction network. In the training process, the image feature extraction network is trained by taking the training sample as the input of the image feature extraction network and the image feature information of the sample image as the output of the image feature extraction network. It should be noted that the training sample in the embodiments of the present disclosure is configured to jointly train a plurality of neural networks involved in the embodiments of the present disclosure. The above description of the training process of the feature extraction network is only exemplary, and the detailed training process of the feature extraction network is described in detail below.

The trained feature extraction network has the ability to extract the image feature information containing the human body region in the image.

In some embodiments, the target image is input into the trained feature extraction network, and the trained feature extraction network extracts the image feature information of the human body region in the target image and outputs the image feature information. In some embodiments, the feature extraction network is a convolutional neural network.

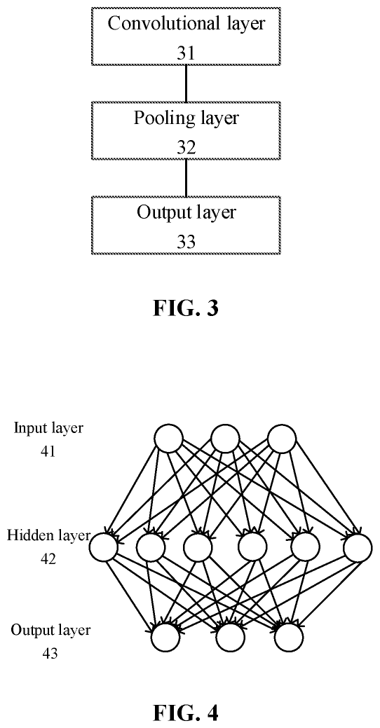

In some embodiments of the present disclosure, the structure of the feature extraction network is shown in FIG. 3, and includes at least one convolutional layer 31, a pooling layer 32 and an output layer 33. The processing process that the feature extraction network performs the feature extraction on the target image is as follows:

acquiring a plurality of feature mapping matrices corresponding to the target image by performing convolution operation on the target image through a plurality of convolutional kernels for extracting features of the human body region in the at least one convolutional layer 31;

averaging the plurality of feature mapping matrices by the pooling layer 32, and determining a feature mapping matrix acquired after the averaging as image feature information corresponding to the target image; and

outputting the acquired image feature information corresponding to the target image by the output layer 33.

In some embodiments, the feature extraction network in the embodiments of the present disclosure includes at least one convolutional layer, a pooling layer and an output layer.

For the convolutional layer, the feature extraction network contains at least one convolutional layer, each convolutional layer contains a plurality of convolutional kernels, and the convolutional kernel is a matrix for extracting the features of the human body region in the target image. The target image input into the feature extraction network is an image matrix composed of pixel values which are, for example, a gray value, RGB values and the like of pixels in the target image. The plurality of convolutional kernels in the convolutional layer perform convolutional operation on the target image. The convolutional operation refers to matrix convolution calculation on the image matrix and a convolutional kernel matrix. One feature mapping matrix is acquired after the image matrix is convolved by one convolutional kernel, and a plurality of feature mapping matrices corresponding to the target image are acquired after the target image is convolved by the plurality of convolutional kernels. Each convolutional kernel can extract a specific feature, and different convolutional kernels are configured to extract different features.

In some embodiments, the convolutional kernel is a convolutional kernel for extracting features of the human body region, and is, for example, a convolutional kernel for extracting a human body vertex feature. A large amount of human body vertex feature information in the target image can be acquired based on a plurality of convolutional kernels for extracting human body vertex features, and can indicate the position information of human body vertices in the target image, and then determine the features of the human body region in the target image.

For the pooling layer, the pooling layer is configured to acquire a feature mapping matrix, namely, the image feature information corresponding to the target image, by averaging values at the same position in the plurality of feature mapping matrices.

For example, the acquired three feature mapping matrices are taken as an example to explain a method for processing the pooling layer of the feature extraction network in the embodiments of the present disclosure, and the feature mapping matrices are 3*3 matrices.

Feature mapping matrix 1:

$$[ \begin{matrix}4 & 3 & 4 \\ 2 & 4 & 3 \\ 2 & 3 & 4\end{matrix} ] .$$

Feature mapping matrix 2:

$$[ \begin{matrix}6 & 7 & 5 \\ 3 & - 1 & 1 \\ 1 & - 1 & 4\end{matrix} ] .$$

Feature mapping matrix 3:

$$[ \begin{matrix}2 & - 4 & - 6 \\ 1 & - 3 & - 4 \\ 0 & - 4 & - 5\end{matrix} ] .$$

Then, the feature mapping matrix acquired by the pooling layer averaging the values at the same position in the three feature mapping matrices is:

$$[ \begin{matrix}4 & 2 & 1 \\ 2 & 0 & 0 \\ 1 & - 2 & 1\end{matrix} ] .$$

The above mapping matrix is the image feature information of the target image. It should be noted that the processing process of the above feature mapping matrices and the feature mapping matrix acquired by averaging are only exemplary, and do not constitute a limitation on the protection scope of the present disclosure.

For the output layer, the output layer is configured to output the acquired image feature information corresponding to the target image.

In some embodiments, the dimension of the feature mapping matrix representing the image feature information is less than the dimension of the resolution of the target image.

After the image feature information of the target image is acquired, the position of a first three-dimensional human body mesh vertex in the target image is determined based on the fully-connected vertex reconstruction network.

In some embodiments, the position of the first three-dimensional human body mesh vertex corresponding to the human body region in the target image output by the fully-connected vertex reconstruction network is acquired by inputting the image feature information of the human body region into the fully-connected vertex reconstruction network in the three-dimensional reconstruction model.

Here, the position of the first three-dimensional human body mesh vertex of the human body region in the target image is acquired by the trained fully-connected vertex reconstruction network based on the image feature information of the target image and the weight matrix corresponding to each layer of the trained fully-connected vertex reconstruction network.

In some embodiments, prior to calling the trained fully-connected vertex reconstruction network, the fully-connected vertex reconstruction network is trained through the image feature information of the sample image output by the feature extraction network. The fully-connected vertex reconstruction network is trained by taking the image feature information of the sample image as the input of the fully-connected vertex reconstruction network and the position of a three-dimensional human body mesh vertex corresponding to the human body region in the sample image as the output of the fully-connected vertex reconstruction network. It should be noted that the above description of the training process of the fully-connected vertex reconstruction network is only exemplary, and the detailed training process of the fully-connected vertex reconstruction network is described in detail below.

The trained fully-connected vertex reconstruction network has the ability to determine the position of the first three-dimensional human body mesh vertex corresponding to the human body region in the target image.

In some embodiments, the image feature information of the human body region in the target image is input into the trained fully-connected vertex reconstruction network; and the trained fully-connected vertex reconstruction network can determine the position of the first three-dimensional human body mesh vertex corresponding to the human body region in the target image based on the image feature information and the weight matrix corresponding to each layer of the fully-connected vertex reconstruction network, and outputs the position of the first three-dimensional human body mesh vertex.

In some embodiments, vertices of the three-dimensional human body mesh are some predefined dense key points, containing three-dimensional key points acquired by relatively fine sampling on a human body surface, such as the key points near the facial features such as features of eyes, nose, mouth ears, eyebrows and key points near joints, or defined key points on the surfaces of the back, stomach and limbs of the human body. For example, 1,000 key points are preset to indicate the information of the complete human body surface. In some embodiments, the number of the vertices of the three-dimensional human body mesh is less than the number of extracted vertices in the image feature information.

In the embodiments of the present disclosure, the structure of the fully-connected vertex reconstruction network is shown in FIG. 4, and includes an input layer 41, at least one hidden layer 42 and an output layer 43. Here, the number of nodes in each layer of the fully-connected vertex reconstruction network is only exemplary, and does not constitute a limitation on the protection scope of the embodiments of the present disclosure. The trained fully-connected vertex reconstruction network acquires the position of the first three-dimensional human body mesh vertex of the human body region in the target image based on the following way:

acquiring, by the input layer 41, an input feature vector by pre-processing the image feature information;

acquiring, by the at least one hidden layer 42, the position of the first three-dimensional human body mesh vertex of the human body region in the target image by performing a nonlinear transformation on the input feature vector based on a weight matrix corresponding to the at least one hidden layer 42; and

outputting, by the output layer 43, the position of the first three-dimensional human body mesh vertex of the human body region in the target image.

In some embodiments, the fully-connected vertex reconstruction network in the embodiments of the present disclosure includes at least one input layer, at least one hidden layer and an output layer.

One hidden layer is taken as an example to explain the structure of the fully-connected vertex reconstruction network in the embodiments of the present disclosure. In the fully-connected vertex reconstruction network, each node in the input layer and each node in the hidden layer are connected to each other, and each node in the hidden layer and each node is the output layer are connected with each other. For the input layer, the fully-connected vertex reconstruction network acquires an input feature vector by pre-processing the input image feature information through the input layer. In some embodiments, when pre-processing the image feature information, the input feature vector is acquired by converting data contained in the feature matrix representing the image feature information into the form of a vector.

For example, the image feature information is as follows:

$$[ \begin{matrix}4 & 2 & 1 \\ 2 & 0 & 0 \\ 1 & - 2 & 1\end{matrix} ] .$$

Then, the input feature vector acquired by pre-processing the image feature information is:
[4 2 1 2 0 0 1 −2 1]

The above image feature information and the pre-processing process thereof are only exemplary, and do not constitute a limitation on the protection scope of the present disclosure.

In some embodiments, the number of nodes in the fully-connected vertex reconstruction network is the same as that of pieces of data contained in the input feature vector.

For the hidden layer, the position of the first three-dimensional human body mesh vertex corresponding to the human body region in the target image is acquired by the hidden layer of the fully-connected vertex reconstruction network performing a nonlinear transformation on the input feature vector based on a weight matrix corresponding to the hidden layer; and an output value of each node in the hidden layer is determined based on output values of all nodes in the input layer, weight values between a current node and all the nodes in the input layer, a bias value of the current node and an activation function.

For example, the output value of each node in the hidden layer is determined according to the following equation:

$${Y}_{k} = f ( {\sum }_{i = 0}^{l} {W}_{ik} * {X}_{i} + {B}_{k} ) ,$$

where Yₖ is an output value of node K in the hidden layer, Wᵢₖ is a weight value between node K in the hidden layer and node i in a previous layer, Xᵢ is an output value of node i in the previous layer, Bₖ is a bias value of node K, and f ( ) is an activation function.

In the embodiments of the present disclosure, the weight matrix is a matrix composed of different weight values. The activation function is, for example, a rectified linear unit (RELU) function.

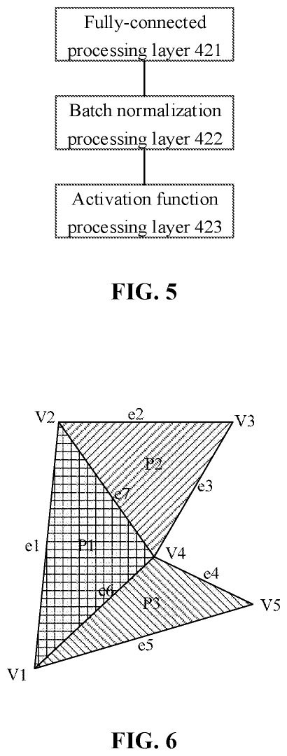

In the embodiments, the structure of each node in the hidden layer is shown in FIG. 5, including a fully-connected (FC) processing layer 421, a batch normalization (BN) processing layer 422, and an activation function (RELU) processing layer 423.

Here, the FC processing layer acquires a value after the fully-connected processing based on the output value of the node in the previous layer, the weight value between the node in the hidden layer and the node in the previous layer, and the bias value of the node in the hidden layer in the above equation. The BN processing layer is configured to perform batch normalization on the value after the fully-connected processing of each node. The activation function processing layer is configured to acquire the output value of the node by performing nonlinear transformation processing on the normalized value.

In some embodiments, the number of hidden layers and the number of nodes in each hidden layer of the fully-connected vertex reconstruction network in the embodiments of the present disclosure can be set according to experience values of those skilled in the art, and are not specifically limited herein.

In some embodiments, the output value of each node in the output layer is determined in the same way as that of each node in the hidden layer. That is, each output value in the output layer is determined based on the output values of all nodes in the hidden layer, weight values between the nodes in the output layer and all the nodes in the hidden layer, and an activation function.

In some embodiments, the number of the nodes in the output layer is three times the number of vertices in the three-dimensional human body mesh. For example, if the number of the vertices in the three-dimensional human body mesh is 1,000, the number of the nodes in the output layer is 3,000. Here, positions of three-dimensional human body mesh vertices are formed by classifying every three of vectors output by the output layer into one group. For example, the vectors output by the output layer are:
[X₁ Y₁ Z₁ X₂ Y₂ Z₂ . . . Xᵢ Yᵢ Zᵢ . . . X₁₀₀₀ Y₁₀₀₀ Z₁₀₀₀].

Then, (X₁, Y₁, Z₁) is the position of vertex i in the three-dimensional human body mesh, and (Xᵢ, Yᵢ, Zᵢ) is the position of vertex i in the three-dimensional human body mesh, wherein i is an integer.

It should be noted that the above process of determining the position of the first three-dimensional human body mesh vertex based on the image feature information is a process of acquiring the position of the three-dimensional human body mesh vertex by decoding a high-dimensional feature matrix representing the image feature information through the plurality of hidden layers.

In the embodiments of the present disclosure, after the position of the first three-dimensional human body mesh vertex of the human body region in the target image is acquired based on the fully-connected vertex reconstruction network, the three-dimensional human body model corresponding to the human body region in the target image is constructed based on a target connection relationship between vertices of the three-dimensional human body mesh and the position of the first three-dimensional human body mesh vertex.

In some embodiments, based on the position of the first three-dimensional human body mesh vertex output by the fully-connected vertex reconstruction network, coordinates of vertices in the three-dimensional human body mesh in the three-dimensional space are determined, and the three-dimensional human body model corresponding to the human body region in the target image is constructed by connecting the vertices of the three-dimensional human body mesh in the space based on the target connection relationship.

In some embodiments, the three-dimensional human body model is a triangular mesh model which is a polygonal mesh composed of triangles and which is widely applied to the graphics and modeling process to construct the surface of a complex object, such as a building, a vehicle or a human body.

In some embodiments, the triangular mesh model is stored in the form of index information. For example, FIG. 6 shows a partial structure of a three-dimensional human body model according to some embodiments of the present disclosure. Here, v1, v2, v3, v4 and v5 are five vertices of the three-dimensional human body mesh. The index information stored in the triangular mesh model includes: a vertex position index list as shown in Table 1, an edge index list as shown in Table 2 and a triangle index list as shown in Table 3.

TABLE 1

| Vertices of three- | |
|---|---|
| dimensional | |
| human body | Space |
| mesh | coordinates |
| v1 | (X1, Y1, Z1) |
| v2 | (X2, Y2, Z2) |
| v3 | (X3, Y3, Z3) |
| v4 | (X4, Y4, Z4) |
| v5 | (X5, Y5, Z5) |

TABLE 2

| | Edge |
|---|---|
| | composition |
| Edge | index |
| e1 | v1, v2 |
| e2 | v2, v3 |
| e3 | v3, v4 |
| e4 | v4, v5 |
| e5 | v5, v1 |
| e6 | v1, v4 |
| e7 | v2, v4 |

TABLE 3

| | Triangle |
|---|---|
| | composition |
| Triangle | index |
| P1 | e1, e6, e7 |
| P2 | e7, e3, e2 |
| P3 | e5, e4, e6 |

Here, the index information shown in Tables 2 and 3 indicates a connection relationship between preset human body key points, and the data shown in Tables 1, 2 and 3 are only exemplary, and only shows the connection relationship between partial vertices of the three-dimensional human body mesh and partial vertices of the three-dimensional human body mesh in the three-dimensional human body model according to the embodiments of the present disclosure. In some embodiments, the vertices in the three-dimensional human body mesh are selected according to the experience of those skilled in the art, and the number of the vertices in the three-dimensional human body mesh can also be set according to the experience of those skilled in the art.

After the position of the first three-dimensional human body mesh vertex is acquired, the position of the first three-dimensional human body mesh vertex in the space is determined, and the three-dimensional human body model is acquired by connecting the vertices of the three-dimensional human body mesh in the space based on the connection relationship shown by the edge index list and the triangle index list.

After the three-dimensional human body model corresponding to the human body region in the target image is constructed, the three-dimensional human body model can be applied to related fields.

In some embodiments, a human body shape and pose parameter corresponding to the three-dimensional human body model is acquired by inputting the three-dimensional human body model into a trained human body parameter regression network.

Here, the human body shape and pose parameter indicates a human body shape and/or a human body pose of the three-dimensional human body model.

In some embodiments, the human body shape and pose parameter in the target image acquired based on the three-dimensional human body model includes parameters representing the human body shape, such as height, BWH (bust, waist, hips), and leg length, and parameters that identify the human body pose, such as a joint angle and human body posture information. The human body shape and pose parameter corresponding to the three-dimensional human body model can be used in animation and film and television industries to generate a three-dimensional animation, and the like.

It should be noted that the application of the human body shape and pose parameter corresponding to the three-dimensional human body model to the animation and film industry is only exemplary, and does not constitute a limitation on the protection scope of the present disclosure. The acquired human body shape and pose parameter can also be used in other fields, such as sports and medical fields. For example, the limb movement and muscle exertion behavior of an object photographed in the target image can be analyzed based on the human body shape and pose parameter acquired by the three-dimensional human body model corresponding to a human body in the target image.

In the process of determining the human body shape and pose parameter corresponding to the three-dimensional human body model, the human body shape and pose parameter corresponding to the three-dimensional human body model output by the trained human body parameter regression network is acquired by inputting the three-dimensional human body model into the trained human body parameter regression network. Here, a training sample used in training the human body parameter regression network includes a three-dimensional human body model sample and a labeled human body shape and pose parameter corresponding to the three-dimensional human body model sample.

Prior to calling the human body parameter regression network, firstly, the human body parameter regression network is trained based on the training sample including the three-dimensional human body model sample and the labeled human body shape and pose parameter corresponding to the three-dimensional human body model sample, and the acquired human body parameter regression network has the ability to acquire the human body shape and pose parameter based on the three-dimensional human body model. In use, the three-dimensional human body model acquired based on the target image is input into the trained human body parameter regression network, and the human body shape and pose parameter corresponding to the three-dimensional human body model is output by the human body parameter regression network.

In some embodiments, the nature of the human body parameter regression network is a fully-connected neural network, a convolutional neural network, and the like, which is not specifically limited in the embodiments of the present disclosure; and the training process of the human body parameter regression network is not specifically limited in the embodiments of the present disclosure.

A method for jointly training the feature extraction network, the fully-connected vertex reconstruction network and the graph convolutional neural network in the three-dimensional reconstruction model is further provided according to some embodiments of the present disclosure. In a process of joint training, consistency constraint training is performed on the fully-connected vertex reconstruction network by the graph convolutional neural network.

In some embodiments, image feature information of a sample human body region is acquired by inputting a sample image containing the sample human body region into an initial feature extraction network.

A three-dimensional human body mesh model corresponding to the sample human body region is acquired by inputting the image feature information of the sample human body region and a topological structure of a human body model mesh into an initial graph convolutional neural network; and the position of a second three-dimensional human body mesh vertex corresponding to the sample human body region is acquired by inputting the image feature information of the sample human body region into an initial fully-connected vertex reconstruction network, wherein the topological structure of the human body model mesh is a predefined topological structure of the human body model mesh, which can be set according to experience and not be limited in the present disclosure.

A trained feature extraction network, a trained fully-connected vertex reconstruction network and a trained graph convolutional neural network are acquired by adjusting model parameters of the feature extraction network, the fully-connected vertex reconstruction network and the graph convolutional neural network based on the three-dimensional human body mesh model of the sample image, the position of the second three-dimensional human body mesh vertex of the sample image and the position of a labeled human body vertex of the sample image.

According to the method for training the three-dimensional reconstruction model provided by the embodiments of the present disclosure, the three-dimensional reconstruction model includes the feature extraction network, the fully-connected vertex reconstruction network and the graph convolutional neural network. The image feature information of the sample human body region in the sample image extracted by the feature extraction network is input into the fully-connected vertex reconstruction network and the graph convolutional neural network separately. The output of the fully-connected vertex reconstruction network is the position of the second three-dimensional human body mesh vertex. The input of the graph convolutional neural network further includes the topological structure of the human body model mesh; and the output of the graph convolutional neural network is the three-dimensional human body mesh model corresponding to the sample human body region. The consistency constraint training is performed on the graph convolutional neural network and the fully-connected vertex reconstruction network based on the position of a third three-dimensional human body mesh vertex determined by the three-dimensional human body mesh model and the position of the second three-dimensional human body mesh vertex output by the fully-connected vertex reconstruction network. The ability of the trained fully-connected vertex reconstruction network to acquire the position of the three-dimensional human body mesh vertex is similar to that of the graph convolutional neural network, but the calculation needed in the trained fully-connected vertex reconstruction network is much less than that in the graph convolutional neural network. In the embodiments of the present disclosure, a position of a first three-dimensional human body mesh vertex corresponding to the human body region is acquired by inputting the image feature information of the human body region into a fully-connected vertex reconstruction network in the three-dimensional reconstruction model. The fully-connected vertex reconstruction network is acquired by performing consistency constraint training on a graph convolutional neural network in the three-dimensional reconstruction model in a training process of the three-dimensional reconstruction model. That is, the trained fully-connected vertex reconstruction network in the three-dimensional reconstruction model is used in one of the steps of constructing a three-dimensional human body model. In this way, the three-dimensional human body model can be constructed efficiently and accurately.

In some embodiments, the sample image and the position of the labeled human body vertex are input into the three-dimensional reconstruction model, and the image feature information of the sample human body region in the sample image is acquired by performing feature extraction on the sample image through the initial feature extraction network in the three-dimensional reconstruction model.

In some embodiments, the feature extraction network is a convolutional neural network. Performing the feature extraction on the sample image by the feature extraction network means that the feature extraction network encodes the input sample image into a high-dimensional feature matrix through multi-layer convolution operation, namely, acquiring the image feature information of the sample image. Here, the process of performing the feature extraction on the sample image by the feature extraction network is the same as the above process of performing the feature extraction on the target image mentioned above, and is not repeated herein.

The acquired image feature information of the sample human body region in the sample image is input into an initial fully-connected vertex reconstruction network and an initial graph convolutional neural network separately.

The position of the second three-dimensional human body mesh vertex in the sample image is determined by the initial fully-connected vertex reconstruction network based on the image feature information of the sample human body region in the sample image and an initial weight matrix corresponding to each layer of the initial fully-connected vertex reconstruction network.

In some embodiments, the position of the second three-dimensional human body mesh vertex in the sample image is acquired by the initial fully-connected vertex reconstruction network decoding the high-dimensional feature matrix representing the image feature information through weight matrices corresponding to a plurality of hidden layers. Here, the process of acquiring the position of the second three-dimensional human body mesh vertex in the sample image by the fully-connected vertex reconstruction network based on the image feature information of the sample image is the same as the process of acquiring the position of the first three-dimensional human body mesh vertex in the target image by the fully-connected vertex reconstruction network based on the image feature information of the target image, and is not repeated herein.

For example, the position of the second three-dimensional human body mesh vertex corresponding to the human body region in the sample image acquired by the initial fully-connected vertex reconstruction network is (X_{Qi}, Y_{Qi}, Z_{Qi}) which indicates the position of an i^{th} three-dimensional human body mesh vertex output by the fully-connected vertex reconstruction network in the space.

The initial graph convolutional neural network determines the three-dimensional human body mesh model based on the image feature information of the sample image and the topological structure of the human body model input into the initial graph convolutional neural network, and determines the position of the third three-dimensional human body mesh vertex corresponding to the three-dimensional human body mesh model.

In some embodiments, the image feature information corresponding to the sample human body region in the sample image output by the initial feature extraction network and the topological structure of the human body model mesh are input into the initial graph convolutional neural network. For example, the topological structure of the human body model mesh is stored information of a triangular mesh model, including a vertex position index list, an edge index list and a triangle index list corresponding to preset vertices of the three-dimensional human body mesh. The initial graph convolutional neural network acquires the spatial positions corresponding to vertices of the three-dimensional human body mesh in the sample image by decoding the high-dimensional feature matrix representing the image feature information, adjusts the spatial positions corresponding to the vertices of the three-dimensional human body mesh in the pre-stored vertex position index list based on the acquired spatial positions of the vertices of the three-dimensional human body mesh, outputs a three-dimensional human body mesh model corresponding to the sample human body region contained in the sample image, and determines the position of the third three-dimensional human body mesh vertex through the adjusted vertex position index list corresponding to the output three-dimensional human body mesh model.

For example, the position of the third three-dimensional human body mesh vertex corresponding to the sample human body region in the sample image acquired by the initial graph convolutional neural network is (X_{T}, Y_{Ti}, Z_{Ti}) which indicates the position of an i^{th} three-dimensional human body mesh vertex output by the graph convolutional neural network in the space.

In some embodiments, the vertices of the three-dimensional human body mesh involved in the positions of the first, second and third vertices of the three-dimensional human body mesh are the same, and the words, first, second and third are used to distinguish the positions of the vertices of the three-dimensional human body mesh acquired under different conditions. For example, for the three-dimensional human body mesh vertex indicating the center point of the left eye, the position of the first three-dimensional human body mesh vertex indicates the position of the center point of the left eye of the human body region in the target image acquired by the trained fully-connected vertex reconstruction network, the position of the second three-dimensional human body mesh vertex indicates the position of the center point of the left eye of the sample human body region in the sample image acquired by the fully-connected vertex reconstruction network in the training process, and the position of the third three-dimensional human body mesh vertex indicates the position of the center point of the left eye of the three-dimensional human body mesh model corresponding to the sample human body region in the sample image acquired by the graph convolutional neural network in the training process.

After the three-dimensional human body mesh model corresponding to the sample human body region and the second three-dimensional human body mesh vertex are acquired, the trained feature extraction network, the trained fully-connected vertex reconstruction network and the trained graph convolutional neural network are acquired by adjusting parameters of the feature extraction network, the fully-connected vertex reconstruction network and the graph convolutional neural network.

In some embodiments, a first loss value is determined based on the position of the third three-dimensional human body mesh vertex corresponding to the three-dimensional human body mesh model and the position of the labeled human body vertex; and a second loss value is determined based on the position of the third three-dimensional human body mesh vertex, the position of the second three-dimensional human body mesh vertex and the position of the labeled human body vertex.

The model parameters of the initial graph convolutional neural network are adjusted based on the first loss value, the model parameters of the initial fully-connected vertex reconstruction network are adjusted based on the second loss value, and the model parameters of the initial feature extraction network are adjusted based on the first loss value and the second loss value until the first loss value as determined falls within a first target range and the second loss value as determined falls within a second target range. Here, the first target range and the second target range are preset ranges, can be set according to experience, and are not limited to the present disclosure.

The process of determining the first loss value based on the position of the third three-dimensional human body mesh vertex and the position of the labeled human body vertex is described below.

In some embodiments, the position of the labeled human body vertex is indicated by three-dimensional mesh vertex coordinates or vertex projection coordinates; and the coordinates of the three-dimensional mesh vertex corresponding to a human body vertex or the coordinates of the vertex projection can be converted through a parameter matrix of an image collection device used during the collection of the sample image. For example, the position of the labeled human body vertex of the sample image is coordinates (x_{Bi}, y_{Bi}) of the vertex projection, which indicate the position of an i^{th} pre-labeled human body vertex.

In the process of determining the first loss value, based on the position of the third three-dimensional human body mesh vertex and the parameter matrix of the image collection device used during the collection of the sample image, projection coordinates corresponding to the position of the third three-dimensional human body mesh vertex are acquired as (x_{Ti}, y_{Ti}), and the equation for determining the first loss value is:

$${S}_{1} = {\sum }_{i = 1}^{n} ( \sqrt{{( {x}_{Ti} - {x}_{Bi} )}^{2} + {( {y}_{Ti} - {y}_{Bi} )}^{2}} ) ,$$

where S₁ represents the first loss value; i represents the i^{th} human body vertex; n represents the total number of human body vertices; (x_{Ti}, y_{Ti}) represents the projection coordinates corresponding to the position of the i^{th} third three-dimensional human body mesh vertex; and (x_{Bi}, y_{Bi}) represents the position of the i^{th} pre-labeled human body vertex, and is the projection coordinates of the vertex.

The above embodiments are only exemplary. In some embodiments, it is also possible to acquire coordinates of a corresponding three-dimensional mesh vertex based on projection coordinates of a pre-labeled vertex and the parameter matrix of the image collection device used during the collection of the sample image, and determine the first loss value based on the coordinates of the three-dimensional mesh vertex and the position of the third three-dimensional human body mesh vertex.

For example, the position of the labeled human body vertex of the sample image is coordinates (X_{B}i, Y_{Bi}, Z_{Bi}) of the three-dimensional mesh vertex, which indicates the position of the i^{th} pre-labeled human body vertex.

In the process of determining the first loss value, the first loss value is determined based on the position of the third three-dimensional human body mesh vertex and the pre-labeled three-dimensional mesh vertex, and the equation for determining the first loss value is:

$${S}_{1} = {\sum }_{i = 1}^{n} ( \sqrt{{( {X}_{Ti} - {X}_{Bi} )}^{2} + {( {Y}_{Ti} - {Y}_{Bi} )}^{2} + {( {Z}_{Ti} - {Z}_{Bi} )}^{2}} ) ,$$

where S₁ represents the first loss value; i represents the i^{th} human body vertex; n represents the total number of human body vertices; (Xᵢ, Y_{Ti}, Z_{Ti}) represents the position of the i^{th} third three-dimensional human body mesh vertex; and (X_{Bi}, Y_{Bi}, Z_{Bi}) represents the position of the i^{th} pre-labeled human body vertex, and is the coordinates of the three-dimensional mesh vertex.

The process of determining the second loss value based on the position of the third three-dimensional human body mesh vertex, the position of the second three-dimensional human body mesh vertex and the position of the labeled human body vertex is described below.

In some embodiments, a consistency loss value is determined based on the position of the second three-dimensional human body mesh vertex, the position of the third three-dimensional human body mesh vertex and a consistency loss function; a prediction loss value is determined based on the position of the second three-dimensional human body mesh vertex, the position of the labeled human body vertex and a prediction loss function; a smoothness loss value is determined based on the position of the second three-dimensional human body mesh vertex and a smoothness loss function; and the second loss value is acquired by performing weighted average operation on the consistency loss value, the prediction loss value and the smoothness loss value.

In some embodiments, the consistency loss value is determined based on the position of the second three-dimensional human body mesh vertex output by the fully-connected vertex reconstruction network and the position of the third three-dimensional human body mesh vertex acquired by the graph convolutional neural network. The consistency loss value indicates a degree of a coincidence between the position of the three-dimensional human body mesh vertex output by the fully-connected vertex reconstruction network and the position of the three-dimensional human body mesh vertex output by the initial graph convolutional neural network, and is used for consistency constraint training The prediction loss value is determined based on the position of the second three-dimensional human body mesh vertex output by the fully-connected vertex reconstruction network and the position of the labeled human body vertex. The prediction loss value indicates a degree of accuracy of the position of the three-dimensional human body mesh vertex output by the fully-connected vertex reconstruction network. The smoothness loss value is determined based on the position of the second three-dimensional human body mesh vertex output by the fully-connected vertex reconstruction network and the smoothness loss function. The smoothness loss value indicates a degree of smoothness of the three-dimensional human body model constructed based on the position of the three-dimensional human body mesh vertex output by the fully-connected vertex reconstruction network, and is used for smoothness constraint on the position of the second three-dimensional human body mesh vertex output by the fully-connected vertex reconstruction network.

In some embodiments, the position of the second three-dimensional human body mesh vertex is output by the fully-connected vertex reconstruction network, and the position of the third three-dimensional human body mesh vertex is acquired based on the three-dimensional human body mesh model output by the graph convolutional neural network. Since the graph convolutional neural network can relatively accurately acquire the position of the three-dimensional human body mesh vertex, the smaller the consistency loss value determined in the training process based on the positions of the second and third three-dimensional human body mesh vertices corresponding to the three-dimensional human body mesh vertices and the consistency loss function is, the closer the position of the second three-dimensional human body mesh vertex output by the fully-connected vertex reconstruction network is to the position of the third three-dimensional human body mesh vertex output by the graph convolutional neural network, and the more accurate the position of the first three-dimensional human body mesh vertex corresponding to the human body region in the target image determined by the trained fully-connected vertex reconstruction network is. Comparing with a graph convolutional neural network, a fully-connected vertex reconstruction network has less need of computation and storage capacity. By constructing a three-dimensional human body model using a fully-connected vertex reconstruction network acquired by performing consistency constraint training on a graph convolutional neural network in the three-dimensional reconstruction model, the efficiency in term of computation and storage capacity can be improved while the accuracy is maintained.

For example, the position of the second three-dimensional human body mesh vertex output by the fully-connected vertex reconstruction network is (X_{Qi}, Y_{Qi}, Z_{Qi}) and the position of the third three-dimensional human body mesh vertex acquired by the graph convolutional neural network is (X_{Ti}, Y_{Ti}, Z_{Ti}), then, the equation for determining the consistency loss value is:

$${a}_{1} = {\sum }_{i = 1}^{n} ( \sqrt{{( {X}_{Ti} - {X}_{Qi} )}^{2} + {( {Y}_{Ti} - {Y}_{Qi} )}^{2} + {( {Z}_{Ti} - {Z}_{Qi} )}^{2}} ) ,$$

where a₁ represents the consistency loss value; i represents the i^{th} human body vertex; n represents the total number of human body vertexes; (X_{Ti}, Y_{Ti}, Z_{Ti}) represents the position of the i^{th} third three-dimensional human body mesh vertex; and (X_{Qi}, Y_{Qi}, Z_{Qi}) represents the position of the i^{th} second three-dimensional human body mesh vertex.

In some embodiments, the position of the labeled human body vertex is coordinates of a three-dimensional mesh vertex or coordinates of a vertex projection; and the coordinates of the three-dimensional mesh vertex corresponding to a human body vertex or the coordinates of the vertex projection can be converted through a parameter matrix of an image collection device used during the collection of the sample image. For example, the position of the labeled human body vertex of the sample image is coordinates (x_{Bi}, y_{Bi}) of the vertex projection, which indicate the position of an i^{th} pre-labeled human body vertex.

In the process of determining the prediction loss value, based on the position of the second three-dimensional human body mesh vertex and the parameter matrix of the image collection device used during the collection of the sample image, projection coordinates corresponding to the position of the second three-dimensional human body mesh vertex are acquired as (x_{Qi}, y_{Qi}), and the equation for determining the prediction loss value is:

$${a}_{2} = {\sum }_{i = 1}^{n} ( \sqrt{{( {x}_{Qi} - {x}_{Bi} )}^{2} + {( {y}_{Qi} - {y}_{Bi} )}^{2}} ) ,$$

where a₂ represents the prediction loss value; i represents the i^{th} human body vertex; n represents the total number of human body vertexes; (x_{Qi}, y_{Qi}) represents projection coordinates corresponding to the position of the i^{th} third three-dimensional human body mesh vertex; and (x_{Bi}, y_{Bi}) represents the position of the i^{th} pre-labeled human body vertex, and is the projection coordinates of the vertex.

The above embodiments are only exemplary. In some embodiments, it is also possible to acquire coordinates of a corresponding three-dimensional mesh vertex based on projection coordinates of a pre-labeled vertex and the parameter matrix of the image collection device used during the collection of the sample image, and determine the prediction loss value based on the coordinates of the three-dimensional mesh vertex and the position of the second three-dimensional human body mesh vertex.

For example, the position of the labeled human body vertex of the sample image is indicated by coordinates (X_{Bi}, Y_{Bi}, Z_{Bi}) of the three-dimensional mesh vertex, which indicate the position of the i^{th} pre-labeled human body vertex.

In the process of determining the prediction loss value, the prediction loss value is determined based on the position of the second three-dimensional human body mesh vertex and the pre-labeled three-dimensional mesh vertex, and the equation for determining the prediction loss value is:

$${a}_{2} = {\sum }_{i = 1}^{n} ( \sqrt{{( {X}_{Qi} - {X}_{Bi} )}^{2} + {( {Y}_{Qi} - {Y}_{Bi} )}^{2} + {( {Z}_{Qi} - {Z}_{Bi} )}^{2}} ) ,$$

where a₂ represents the prediction loss value; i represents the i^{th} human body vertex; n represents the total number of human body vertexes; (X_{Qi}, Y_{Qi}, Z_{Qi}) represents the position of the i^{th} second three-dimensional human body mesh vertex; and (X_{Bi}, Y_{Bi}, Z_{Bi}) represents the position of the i^{th} pre-labeled human body vertex, and is the coordinates of the three-dimensional mesh vertex.

In some embodiments, in the process of determining the smoothness loss value, the smoothness loss function is Laplace function, and the smoothness loss value is acquired by inputting the position of the second three-dimensional human body mesh vertex corresponding to the sample human body region in the sample image output by the fully-connected vertex reconstruction network into the Laplace function, wherein the greater the smoothness loss value is, the less smooth the surface of the acquired three-dimensional human body model is when the three-dimensional human body model is constructed based on the position of the second three-dimensional human body mesh vertex, otherwise, the smaller the smoothness loss value is, the smoother the surface of the acquired three-dimensional human body model is.

The equation for determining the smoothness loss value is:

a₃=∥(L)∥,

where a₃ represents the smoothness loss value; and L is a Laplace matrix determined based on the position of the second three-dimensional human body mesh vertex.

After the consistency loss value, the prediction loss value and the smoothness loss value are acquired, the second loss value is acquired by performing weighted average operation based on the acquired consistency loss value, prediction loss value and smoothness loss value.

The equation for determining the second loss value is:

$${S}_{2} = \frac{{m}_{1} {a}_{1} + {m}_{2} {a}_{2} + {m}_{3} {a}_{3}}{{m}_{1} + {m}_{2} + {m}_{3}} ,$$

where S₂ represents the second loss value; m₁ represents a weight corresponding to the consistency loss value; a₁ represents the consistency loss value; m₂ represents a weight corresponding to the prediction loss value; a₂ represents the prediction loss value; m₃ represents a weight corresponding to the smoothness loss value; and a₃ represents the smoothness loss value.

It should be noted that the values of the weights corresponding to the consistency loss value, the prediction loss value and the smoothness loss value may be the empirical values of those skilled in the art, and are not specifically limited in the embodiments of the present disclosure.

In the embodiments of the present disclosure, in the process of determining the second loss value, smoothness constraint is performed on the training of the fully-connected vertex reconstruction network based on the smoothness loss value, such that the three-dimensional human body model constructed based on the position of the three-dimensional human mesh vertex output by the fully-connected vertex reconstruction network is smoother. In some embodiments, the second loss value is also determined based on the consistency loss value and the prediction loss value. For example, the equation for determining the second loss value is:

$${S}_{2} = \frac{{m}_{1} {a}_{1} + {m}_{2} {a}_{2}}{{m}_{1} + {m}_{2}} ,$$

where S₂ represents the second loss value; m₁ represents a weight corresponding to the consistency loss value; a₁ represents the consistency loss value; m₂ represents a weight corresponding to the prediction loss value; and a₂ represents the prediction loss value.

After the first loss value and the second loss value are determined, the trained feature extraction network, the trained fully-connected vertex reconstruction network and the trained graph convolutional neural network are acquired by adjusting the model parameters of the initial graph convolutional neural network based on the first loss value, the model parameters of the initial fully-connected vertex reconstruction network based on the second loss value, and the model parameters of the initial feature extraction network based on the first loss value and the second loss value until the first loss value as determined falls within a first target range and the second loss value as determined falls within a second target range. Here, the first target range and the second target range may be set by those skilled in the art according to empirical values, and are not specifically limited in the embodiments of the present disclosure.

As shown in FIG. 7, it is a schematic diagram of a training process according to some embodiments of the present disclosure. As shown in FIG. 7, a training process is described as follow: sample image and the position of a labeled human body vertex (i.e. the position of a pre-labeled human body vertex) are input into a feature extraction network, and image feature information of a sample human body region in the sample image is acquired by the feature extraction network performing feature extraction on the sample image; the image feature information of the sample human body region are then input into a graph convolutional neural network and a fully-connected vertex reconstruction network separately; the position of a second three-dimensional human body mesh vertex output by the fully-connected vertex reconstruction network is acquired by inputting the image feature information of the sample human body region into a fully-connected vertex reconstruction network; a three-dimensional human body mesh model output by the graph convolutional neural network is acquired by inputting the image feature information of the sample human body region and a predefined topological structure of the human body model mesh into the graph convolutional neural network, and the position of a third three-dimensional human body mesh vertex corresponding to the three-dimensional human body mesh model is further determined. After obtaining the above mentioned data/information, a first loss value is determined based on the position of the second three-dimensional human body mesh vertex and the position of the labeled human body vertex; and a second loss value is determined based on the position of the third three-dimensional human body mesh vertex, the position of the second three-dimensional human body mesh vertex and the position of the labeled human body vertex; and a trained feature extraction network, a trained fully-connected vertex reconstruction network and a trained graph convolutional neural network are acquired by adjusting a model parameter of the graph convolutional neural network based on the first loss value, adjusting a model parameter of the fully-connected vertex reconstruction network based on the second loss value, and adjusting a model parameter of the feature extraction network based on the first loss value and the second loss value.

In the embodiments of the present disclosure, after the trained feature extraction network, the trained fully-connected vertex reconstruction network and the trained graph convolutional neural network are acquired, a trained three-dimensional reconstruction model is acquired by deleting the trained graph convolutional neural network in the three-dimensional reconstruction model. The trained three-dimensional reconstruction model contains the feature extraction network and the fully-connected vertex reconstruction network.

An apparatus for constructing a three-dimensional human body model is further provided according to some embodiments of the present disclosure. Since the apparatus corresponds to the method for constructing the three-dimensional human body model according to the embodiments of the present disclosure and the principle of this apparatus for solving problems is similar to this method, the implementation of this apparatus may refer to the implementation of the method, which is not repeated herein.

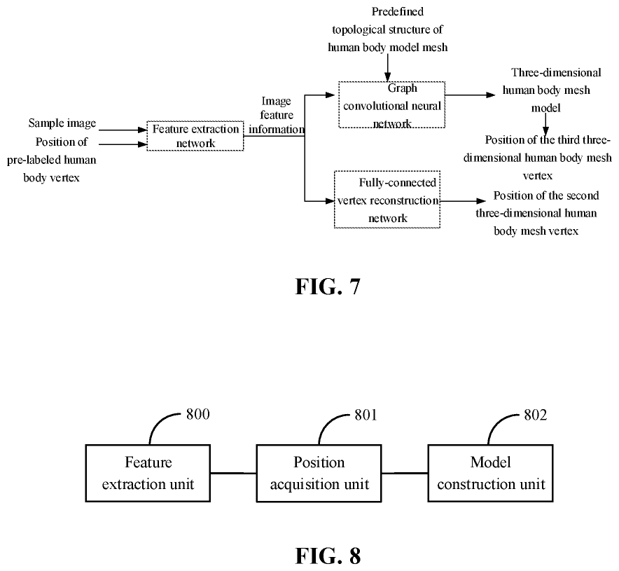

FIG. 8 is a block diagram of an apparatus for constructing a three-dimensional human model according to some embodiments of the present disclosure. Referring to FIG. 8, the apparatus includes a feature extraction unit 800, a position acquisition unit 801 and a model construction unit 802.

The feature extraction unit 800 is configured to acquire image feature information of a human body region by inputting a target image containing the human body region into a feature extraction network in a three-dimensional reconstruction model.

The position acquisition unit 801 is configured to acquire the position of a first three-dimensional human body mesh vertex corresponding to the human body region by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process.

The position acquisition unit 801 is configured to construct the three-dimensional human body model corresponding to the human body region based on a target connection relationship between three-dimensional human body mesh vertices and the position of the first three-dimensional human body mesh vertex.

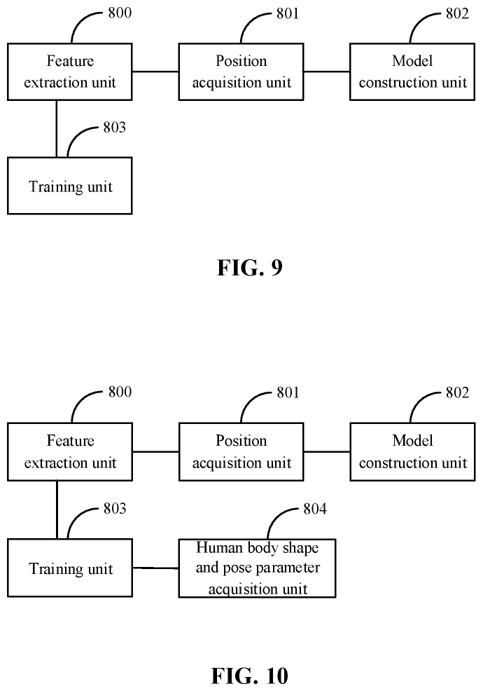

FIG. 9 is a block diagram of another apparatus for constructing a three-dimensional human model according to some embodiments of the present disclosure. Referring to FIG. 9, the apparatus further includes a training unit 803.

The training unit 803 is specifically configured to jointly train the feature extraction network, the fully-connected vertex reconstruction network and the graph convolutional neural network in the three-dimensional reconstruction model based on the following way:

acquiring image feature information of a sample human body region by inputting a sample image containing the sample human body region into an initial feature extraction network;

acquiring a three-dimensional human body mesh model corresponding to the sample human body region by inputting the image feature information of the sample human body region and a topological structure of a human body model mesh into an initial graph convolutional neural network, and acquiring the position of a second three-dimensional human body mesh vertex corresponding to the sample human body region by inputting the image feature information of the sample human body region into an initial fully-connected vertex reconstruction network; and

acquiring a trained feature extraction network, a trained fully-connected vertex reconstruction network and a trained graph convolution neural network by adjusting model parameters of the feature extraction network, the fully-connected vertex reconstruction network and the graph convolutional neural network based on the three-dimensional human body mesh model, the position of the second three-dimensional mesh vertex and the position of a labeled human body vertex of the sample image.

In some embodiments, the training unit 803 is further configured to acquire a trained three-dimensional reconstruction model by deleting the graph convolutional neural network in the three-dimensional reconstruction model.

In some embodiments, the training unit 803 is configured to:

determine a first loss value based on the position of a third three-dimensional human body mesh vertex corresponding to the three-dimensional human body mesh model and the position of the labeled human body vertex, wherein the position of the labeled human body vertex is indicated by vertex projection coordinates or three-dimensional mesh vertex coordinates;

determine a second loss value based on the position of the third three-dimensional human body mesh vertex, the position of the second three-dimensional human body mesh vertex and the position of the labeled human body vertex; and

adjust the model parameters of the initial graph convolutional neural network based on the first loss value, the model parameters of the initial fully-connected vertex reconstruction network based on the second loss value, and the model parameters of the initial feature extraction network based on the first loss value and the second loss value until the first loss value as determined falls within a first target range and the second loss value as determined falls within a second target range.

In some embodiments, the training unit 803 is specifically configured to:

determine a consistency loss value based on the position of the second three-dimensional human body mesh vertex, the position of the third three-dimensional human body mesh vertex and a consistency loss function, wherein the consistency loss value indicates a degree of a coincidence between a position of the three-dimensional human body mesh vertex output by the fully-connected vertex reconstruction network and a position of the three-dimensional human body mesh vertex output by the initial graph convolution neural network;

determine a prediction loss value based on the position of the second three-dimensional human body mesh vertex, the position of the labeled human body vertex and a prediction loss function, wherein the prediction loss value indicates a degree of accuracy of the position of the three-dimensional human body mesh vertex output by the fully-connected vertex reconstruction network; and

acquire the second loss value by performing weighted average operation on the consistency loss value and the prediction loss value.

In some embodiments, the training unit 803 is specifically configured to:

acquire the second loss value by performing the weighted average operation on the consistency loss value, the prediction loss value and a smoothness loss value,

wherein the smoothness loss value indicates a degree of smoothness of the three-dimensional human body model constructed based on the position of the three-dimensional human body mesh vertex output by the fully-connected vertex reconstruction network, and the smoothness loss value is determined based on the position of the second three-dimensional human body mesh vertex and a smoothness loss function.

FIG. 10 is a block diagram of yet another apparatus for constructing a three-dimensional human model according to some embodiments of the present disclosure. Referring to FIG. 10, the apparatus further includes a human body shape and pose parameter acquisition unit 804.

The human body shape and pose parameter acquisition unit 804 is configured to acquire a human body shape and pose parameter corresponding to the three-dimensional human body model by inputting the three-dimensional human body model into a trained human body parameter regression network, wherein the human body shape and pose parameter indicates a human body shape and/or a human body pose of the three-dimensional human body model.

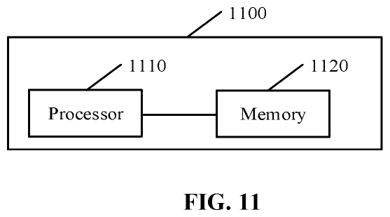

FIG. 11 is a block diagram of an electronic device 1100 according to some embodiments of the present disclosure. The electronic device 1100 includes at least one processor 1110 and at least one memory 1120.

In some embodiments, the memory 1120 stores a program code. The memory 1120 mainly includes a program storage area and a data storage area, wherein the program storage area stores an operating system, programs required for running instant messaging functions, and the like; and the data storage area stores all kinds of instant messaging information, operation instruction sets, etc.

In some embodiments, the memory 1120 is a volatile memory, such as a random-access memory (RAM). In some embodiments, the memory 1120 is also a non-volatile memory, such as a read-only memory, a flash memory, a hard disk drive (HDD) or a solid-state drive (SSD), or any other media that can be configured to carry or store desired program codes in the form of instructions or data structures and that can be accessed by a computer, but is not limited thereto. In some embodiments, the memory 1120 is a combination of the above memories.

In some embodiments, the processor 1110 includes one or more central processing unit (CPUs) or digital processing units, etc. When calling the program code stored in the memory 1120, the processor 1110 executes any one of the above methods for constructing a three-dimensional human body model or any one of methods possibly involved in any one of the methods for constructing a three-dimensional human body model.

A non-volatile readable storage medium storing one or more instructions therein is further provided according to some embodiments of the present disclosure, and for example, is a memory 1120 including one or more instructions. The above instruction is executable by a processor 1110 of an electronic device 1100 to complete any one of the above methods for constructing a three-dimensional human body model or any one of methods possibly involved in any one of the methods for constructing a three-dimensional human body model. In some embodiments, the storage medium is a non-transitory computer-readable storage medium. For example, the non-transitory computer-readable storage medium is the ROM, a random access memory (RAM), a CD-ROM, a magnetic tape, a floppy disc, an optical data storage device, etc.

A computer program product is further provided according to some embodiments of the present disclosure. The computer program product, when run on an electronic device, causes the electronic device to execute any one of the above methods for constructing a three-dimensional human body model or any one of methods possibly involved in any one of the methods for constructing a three-dimensional human body model.

All the embodiments of the present disclosure may be executed individually or in combination with other embodiments, which are all regarded as being included in the protection scope of the present disclosure.

What is claimed is:

1. A method for constructing a three-dimensional human body model, comprising:
acquiring image feature information of a human body region by inputting a target image containing the human body region into a feature extraction network in a three-dimensional reconstruction model;
acquiring a position of a first three-dimensional human body mesh vertex corresponding to the human body region by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process of the three-dimensional reconstruction model; and
constructing the three-dimensional human body model corresponding to the human body region based on a target connection relationship between three-dimensional human body mesh vertices and the position of the first three-dimensional human body mesh vertex.

2. The method according to claim 1, wherein the feature extraction network, the fully-connected vertex reconstruction network and the graph convolutional neural network in the three-dimensional reconstruction model are jointly trained by:
acquiring image feature information of a sample human body region by inputting a sample image containing the sample human body region into an initial feature extraction network;
acquiring a three-dimensional human body mesh model corresponding to the sample human body region by inputting the image feature information of the sample human body region and a topological structure of a human body model mesh into an initial graph convolutional neural network, and acquiring a position of a second three-dimensional human body mesh vertex corresponding to the sample human body region by inputting the image feature information of the sample human body region into an initial fully-connected vertex reconstruction network; and
acquiring a trained feature extraction network, a trained fully-connected vertex reconstruction network and a trained graph convolutional neural network by adjusting model parameters of the feature extraction network, the fully-connected vertex reconstruction network and the graph convolutional neural network based on the three-dimensional human body mesh model of the sample image, the position of the second three-dimensional human body mesh vertex of the sample image and a position of a labeled human body vertex of the sample image.

3. The method according to claim 2, further comprising:
acquiring a trained three-dimensional reconstruction model by deleting the graph convolutional neural network in the three-dimensional reconstruction model.

4. The method according to claim 2, wherein said adjusting the model parameters of the feature extraction network, the fully-connected vertex reconstruction network and the graph convolutional neural network based on the three-dimensional human body mesh model, the position of the second three-dimensional human body mesh vertex and the position of the labeled human body vertex of the sample image comprises:
determining a first loss value based on a position of a third three-dimensional human body mesh vertex corresponding to the three-dimensional human body mesh model and the position of the labeled human body vertex, wherein the position of the labeled human body vertex is indicated by vertex projection coordinates or three-dimensional mesh vertex coordinates;
determining a second loss value based on the position of the third three-dimensional human body mesh vertex, the position of the second three-dimensional human body mesh vertex and the position of the labeled human body vertex; and
adjusting the model parameters of the initial graph convolutional neural network based on the first loss value, adjusting the model parameters of the initial fully-connected vertex reconstruction network based on the second loss value, and adjusting the model parameters of the initial feature extraction network based on the first loss value and the second loss value until the first loss value as determined falls within a first target range and the second loss value as determined falls within a second target range.

5. The method according to claim 4, wherein said determining the second loss value based on the position of the third three-dimensional human body mesh vertex, the position of the second three-dimensional human body mesh vertex and the position of the labeled human body vertex comprises:
determining a consistency loss value based on the position of the second three-dimensional human body mesh vertex, the position of the third three-dimensional human body mesh vertex and a consistency loss function, wherein the consistency loss value indicates a degree of coincidence between a position of a three-dimensional human body mesh vertex output by the fully-connected vertex reconstruction network and a position of a three-dimensional human body mesh vertex output by the initial graph convolutional neural network;
determining a prediction loss value based on the position of the second three-dimensional human body mesh vertex, the position of the labeled human body vertex and a prediction loss function, wherein the prediction loss value indicates a degree of accuracy of the position of the three-dimensional human body mesh vertex output by the fully-connected vertex reconstruction network; and
acquiring the second loss value by performing weighted average operation on the consistency loss value and the prediction loss value.

6. The method according to claim 5, wherein said acquiring the second loss value by performing the weighted average operation on the consistency loss value and the prediction loss value comprises:
acquiring the second loss value by performing the weighted average operation on the consistency loss value, the prediction loss value and a smoothness loss value,
wherein the smoothness loss value indicates a degree of smoothness of the three-dimensional human body model constructed based on the position of the three-dimensional human body mesh vertex output by the fully-connected vertex reconstruction network, and the smoothness loss value is determined based on the position of the second three-dimensional human body mesh vertex and a smoothness loss function.

7. The method according to claim 1, further comprising:
acquiring a human body shape and pose parameter corresponding to the three-dimensional human body model by inputting the three-dimensional human body model into a trained human body parameter regression network, wherein the human body shape and pose parameter indicates a human body shape and/or a human body pose of the three-dimensional human body model.

8. The method according to claim 1, wherein said constructing the three-dimensional human body model corresponding to the human body region based on the target connection relationship between the three-dimensional human body mesh vertices and the position of the first three-dimensional human body mesh vertex comprises:
determining coordinates of the three-dimensional human body mesh vertices in a three-dimensional space based on the position of the first three-dimensional human body mesh vertex; and
acquiring the three-dimensional human body model corresponding to the human body region by connecting the three-dimensional human body mesh vertices in the three-dimensional space according to the target connection relationship.

9. An electronic device, comprising:
one or more processors; and
a memory configured to store one or more instructions executable by the one or more processors,
wherein the one or more processors, when loading and executing the one or more instructions, are caused to perform:
acquiring image feature information of a human body region by inputting a target image containing the human body region into a feature extraction network in a three-dimensional reconstruction model;
acquiring a position of a first three-dimensional human body mesh vertex corresponding to the human body region by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process; and
constructing the three-dimensional human body model corresponding to the human body region based on a target connection relationship between three-dimensional human body mesh vertices and the position of the first three-dimensional human body mesh vertex.

10. The electronic device according to claim 9, wherein the one or more processors, when loading and executing the one or more instructions, are caused to perform:
acquiring image feature information of a sample human body region by inputting a sample image containing the sample human body region into an initial feature extraction network;
acquiring a three-dimensional human body mesh model corresponding to the sample human body region by inputting the image feature information of the sample human body region and a topological structure of a human body model mesh into an initial graph convolutional neural network, and acquiring a position of a second three-dimensional human body mesh vertex corresponding to the sample human body region by inputting the image feature information of the sample human body region into an initial fully-connected vertex reconstruction network; and
acquiring a trained feature extraction network, a trained fully-connected vertex reconstruction network and a trained graph convolutional neural network by adjusting model parameters of the feature extraction network, the fully-connected vertex reconstruction network and the graph convolutional neural network based on the three-dimensional human body mesh model, the position of the second three-dimensional human body mesh vertex and a position of a labeled human body vertex of the sample image.

11. The electronic device according to claim 10, wherein the one or more processors, when loading and executing the one or more instructions, are caused to perform:
acquiring a trained three-dimensional reconstruction model by deleting the graph convolutional neural network in the three-dimensional reconstruction model.

12. The electronic device according to claim 10, wherein the one or more processors, when loading and executing the one or more instructions, are caused to perform:
determining a first loss value based on a position of a third three-dimensional human body mesh vertex corresponding to the three-dimensional human body mesh model and the position of the labeled human body vertex, wherein the position of the labeled human body vertex is indicated by vertex projection coordinates or three-dimensional mesh vertex coordinates;
determining a second loss value based on the position of the third three-dimensional human body mesh vertex, the position of the second three-dimensional human body mesh vertex and the position of the labeled human body vertex; and
adjusting the model parameters of the initial graph convolutional neural network based on the first loss value, adjusting the model parameters of the initial fully-connected vertex reconstruction network based on the second loss value, and adjusting the model parameters of the initial feature extraction network based on the first loss value and the second loss value until the first loss value as determined falls within a first target range and the second loss value as determined falls within a second target range.

13. The electronic device according to claim 12, wherein the one or more processors, when loading and executing the one or more instructions, are caused to perform:
determining a consistency loss value based on the position of the second three-dimensional human body mesh vertex, the position of the third three-dimensional human body mesh vertex and a consistency loss function, wherein the consistency loss value indicates a degree of coincidence between a position of a three-dimensional human body mesh vertex output by the fully-connected vertex reconstruction network and a position of a three-dimensional human body mesh vertex output by the initial graph convolutional neural network;
determining a prediction loss value based on the position of the second three-dimensional human body mesh vertex, the position of the labeled human body vertex and a prediction loss function, wherein the prediction loss value indicates a degree of accuracy of the position of the three-dimensional human body mesh vertex output by the fully-connected vertex reconstruction network; and
acquiring the second loss value by performing weighted average operation on the consistency loss value and the prediction loss value.

14. The electronic device according to claim 13, wherein the one or more processors, when loading and executing the one or more instructions, are caused to perform:
acquiring the second loss value by performing the weighted average operation on the consistency loss value, the prediction loss value and a smoothness loss value,
wherein the smoothness loss value indicates a degree of smoothness of the three-dimensional human body model constructed based on the position of the three-dimensional human body mesh vertex output by the fully-connected vertex reconstruction network, and the smoothness loss value is determined based on the position of the second three-dimensional human body mesh vertex and a smoothness loss function.

15. The electronic device according to claim 9, wherein the one or more processors, when loading and executing the one or more instructions, are caused to perform:
acquiring a human body shape and pose parameter corresponding to the three-dimensional human body model by inputting the three-dimensional human body model into a trained human body parameter regression network, wherein the human body shape and pose parameter indicates a human body shape and/or a human body pose of the three-dimensional human body model.

16. The electronic device according to claim 9, wherein the one or more processors, when loading and executing the one or more instructions, are caused to perform:
determining coordinates of the three-dimensional human body mesh vertices in a three-dimensional space based on the position of the first three-dimensional human body mesh vertex; and
acquiring the three-dimensional human body model corresponding to the human body region by connecting the three-dimensional human body mesh vertices in the three-dimensional space according to the target connection relationship.

17. A non-transitory computer-readable storage medium storing one or more instructions therein, wherein the one or more instructions, when loaded and executed by a processor of an electronic device, cause the electronic device to perform:
acquiring image feature information of a human body region by inputting a target image containing the human body region into a feature extraction network in a three-dimensional reconstruction model;
acquiring a position of a first three-dimensional human body mesh vertex corresponding to the human body region by inputting the image feature information of the human body region into a fully-connected vertex reconstruction network in the three-dimensional reconstruction model, wherein the fully-connected vertex reconstruction network is acquired by performing consistency constraint training on a graph convolutional neural network in the three-dimensional reconstruction model in a training process; and
constructing the three-dimensional human body model corresponding to the human body region based on a target connection relationship between three-dimensional human body mesh vertices and the position of the first three-dimensional human body mesh vertex.

18. The non-transitory readable storage medium according to claim 17, wherein the one or more instructions, when loaded and executed by the processor of the electronic device, cause the electronic device to perform:
acquiring image feature information of a sample human body region by inputting a sample image containing the sample human body region into an initial feature extraction network;
acquiring a three-dimensional human body mesh model corresponding to the sample human body region by inputting the image feature information of the sample human body region and a topological structure of a human body model mesh into an initial graph convolutional neural network, and acquiring a position of a second three-dimensional human body mesh vertex corresponding to the sample human body region by inputting the image feature information of the sample human body region into an initial fully-connected vertex reconstruction network; and
acquiring a trained feature extraction network, a trained fully-connected vertex reconstruction network and a trained graph convolutional neural network by adjusting model parameters of the feature extraction network, the fully-connected vertex reconstruction network and the graph convolutional neural network based on the three-dimensional human body mesh model, the position of the second three-dimensional human body mesh vertex and a position of a labeled human body vertex of the sample image.

19. The non-transitory readable storage medium according to claim 18, wherein the one or more instructions, when loaded and executed by the processor of the electronic device, cause the electronic device to perform:
acquiring a trained three-dimensional reconstruction model by deleting the graph convolutional neural network in the three-dimensional reconstruction model.

20. The non-transitory readable storage medium according to claim 18, wherein the one or more instructions, when loaded and executed by the processor of the electronic device, cause the electronic device to perform:
determining a first loss value based on a position of a third three-dimensional human body mesh vertex corresponding to the three-dimensional human body mesh model and the position of the labeled human body vertex, wherein the position of the labeled human body vertex is indicated by vertex projection coordinates or three-dimensional mesh vertex coordinates;
determining a second loss value based on the position of the third three-dimensional human body mesh vertex, the position of the second three-dimensional human body mesh vertex and the position of the labeled human body vertex; and
adjusting the model parameters of the initial graph convolutional neural network based on the first loss value, adjusting the model parameters of the initial fully-connected vertex reconstruction network based on the second loss value, and adjusting the model parameters of the initial feature extraction network based on the first loss value and the second loss value until the first loss value as determined falls within a first target range and the second loss value as determined falls within a second target range.
